(19) United States
(12) Patent Application Publication
(10) Pub. No.: US 2017/0071182 A1
(43) Pub. Date: Mar. 16, 2017

(54) Tool for Removal of Debris From a Fishing Line

(71) Applicant: Jared Mark Larson, Darien, WI (US)

(72) Inventor: Jared Mark Larson, Darien, WI (US)

(21) Appl. No.: 15/265,470

(22) Filed: Sep. 14, 2016

Related U.S. Application Data
(60) Provisional application No. 62/283,794, filed on Sep. 14, 2015.

(51) Int. Cl. A01K 97/16

(52) U.S. Cl. CPC A01K 97/16

(57) ABSTRACT

In one embodiment, the disclosure relates to a tool for removing debris from a fishing line. In one embodiment, the tool is attached to the fishing pole. In yet another embodiment, the tool comprises a body having a first region with an opening with a series of notches for insertion of a shaft and a second region with a curved end.

### CROSS-REFERENCE TO RELATED APPLICATIONS

This application claims priority to and is a non-provisional patent application of U.S. Provisional Patent Application No. 62/283,794 filed Sep. 14, 2015, which is incorporated herein by reference in its entirety.

### FIELD

This disclosure relates generally to fishing. In one embodiment, the disclosure relates to a tool for removing debris from a fishing line. In still another embodiment, the tool can be attached to a fishing pole.

### BACKGROUND

Fishermen are often troubled with either floating or rooted weeds or other marine plants entangling their lures and other parts of their fishing equipment. One of the most troublesome plants in this respect are cottonwood seeds. Cottonwood seeds fall from the trees and have a tendency to cling to a passing fishing line and to slide along it until they engage a projection, such as the swivel that connects the line to the leader, where they pile up.

Further, debris may slide past the swivel and pile up on the lure, a sinker or any other piece of equipment that may be attached to the line. Sometimes the entanglement results in breakage of the line with loss of part of the equipment. Various attempts have been made to solve this problem by constructing lures and hooks with guards intended to prevent entanglement with the weeds. However, such guards are not always completely effective. Furthermore, the guards decrease the efficiency of the hooks and make it easier for a fish to avoid capture.

Thus, a need still exists for a device for efficient removal of debris from a fishing line.

### SUMMARY

In one embodiment, the disclosure relates to a tool for removing debris from fishing line. In another embodiment, the tool can be attached to a shaft of a fishing rod and remain attached to the shaft while fishing. In another embodiment, the tool comprises a body having a first portion with a first end and a second end that attaches to a portion of a fishing pole with. In yet another embodiment, the first portion comprises a cavity or opening. In still another embodiment, the cavity or opening is formed by a first sidewall, a second sidewall and a bottom portion, with the top portion open. In another embodiment, the first sidewall an second sidewall have one or more groves or notches. In still another embodiment, the first sidewall and the second sidewall move closer together in the direction from the first end to the second end of the first portion.

In one embodiment, the disclosure relates to a pole-attachable fishing tool comprising a body, the body having (a) a first region having an opening with at least a first notch and a second notch, each notch sized to receive a shaft of a fishing pole; (b) a second region that is curved at the end, and (c) a third region coupling the first region to the second region, and (d) a slot extending from about the third region of the body to the second region that allows for insertion of a fishing line. In one embodiment, each of the first and second notches are formed from a first angular portion, an open middle portion, and a second angular portion.

In another embodiment, the disclosure relates to a pole-attachable fishing tool comprising a body, the body having (a) a first region comprising a first sidewall, and a second sidewall, the inner portions of the first sidewall and second sidewalls are curved, and move away from one another to create an open region sized to receive a shaft of a fishing rod; (b) a curved second region, and (c) a third region coupling the first region to the second region, and (d) a slot extending from about the third region of the body to the second region that allows for insertion of a fishing line.

In one embodiment, the disclosure relates to a pole-attachable fishing tool comprising a body having a first region with a first end and a second end and an opening that narrows progressively from the first end to the second end, a second region with a curved end; and a third region connecting the first and second regions, wherein the opening can accommodate attachment of at least two different sized shafts of fishing rods.

In one embodiment, the tool has a body comprising a first end and a second end, and a region connecting the first end to the second end. In still another embodiment, the tool has a body comprising a first end, a second end, and a center region connecting the first end to the second end. In one embodiment, the second end concludes with a curved structure. In one embodiment, the second end concludes in a curved shape.

One advantage of the tool disclosed herein is that the tool is a single, stable solid structure. The tool is not made of multiple pieces.

One advantage of the tool disclosed herein is that the tool is not blade shaped. The tool can mount directly to the fishing rod and be used during fishing. With the tool disclosed herein, the tool can be attached or mounted to the fishing rod, and used to remove debris.

One advantage of the tool disclosed herein is that there is no need to remove the tool while fishing.

One advantage of the tool is that debris can be removed without cutting the fishing line, and debris can be removed without having to use bare hands.

One advantage of the tool is that the tool greatly reduces the amount of debris that can enter the fishing reels.

One advantage of the tool disclosed herein is that the tool allows the fishing line to cast freely through the fishing pole eyelets while preventing the fishing reel from jamming with cottonwood seeds and other debris that attaches to the fishing line while casting and retrieving.

One advantage of the tool disclosed herein is that the tool comprises a region with a gap that allows fishing line to cast freely through and return freely through while fishing. The gap catches debris but does not “clean” the line.

### BRIEF DESCRIPTION OF THE DRAWINGS

FIG. 1 is a schematic view of a fishing rod and associated components.

FIG. 2A and 2B are side views of one embodiment of the tool disclosed herein.

FIG. 3A is an exploded view of one embodiment of the first region of the tool disclosed herein.

FIG. 3B is an exploded view of one embodiment of the first region of the tool disclosed herein showing representative diameters.

FIG. 4 is a perspective view of one embodiment of the tool disclosed herein.

FIG. 5 is a perspective view of one embodiment of the tool disclosed herein

FIG. 6A is a top view of one embodiment of the tool disclosed herein.

FIG. 6B is a bottom view of one embodiment of the tool disclosed herein.

FIGS. 7A, 7B, and 7C are schematics depicting one embodiment of a method for removing debris from a tool disclosed herein.

FIG. 8A is a schematic of one embodiment of a tool disclosed herein attached to a shaft of a fishing rod.

FIG. 8B is a schematic of one embodiment of a tool disclosed herein interacting with a fishing line.

### DETAILED DESCRIPTION

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, dimensions and diameters and other parameter ranges recited in the methods.

As used herein, the term “aperture” refers to an opening, hole, or gap.

As used herein, the term “debris” refers to material that can knot a fishing line and/or impede a fishing reel. The term debris includes but is not limited to weeds, seeds, cottonwood seeds, cotton and similar material.

As used herein, the term “notch” refers to a groove, indentation or gap that is sized to receive and hold an object. The terms “notch” and “groove” are used interchangeably.

As used herein, the term “securely” refers to a stable attachment of the tool to a shaft of a fishing rod, such that the tool remains affixed to the shaft while casting and fishing.

As used herein, the term “slot” refers to a long, narrow notch or slit in a body or structure that allows for something to be inserted.

In one embodiment, the disclosure relates to a tool for removing debris from fishing line. In another embodiment, the tool attaches to the fishing pole. In one embodiment, the disclosure relates to a tool that prevents cottonwood seeds from clogging a fishing reel while casting and retrieving.

In still another embodiment, the tool attaches to the fishing pole at any point above the first eyelet of the fishing pole.

In still another embodiment, the tool can be used with any fishing rod and caster including baitcast, spincast, spinning rod and reel combos. The tool can be used with a fishing rod used to fish in fresh water or salt water.

In one embodiment, the tool is a single piece. In one embodiment, the tool has any number of different diameter rounded slots located on a first side or first end of the tool. The slots are different diameters to be universal to any action fishing pole and to fit anywhere on the pole. The different diameter rounded slots are stacked on top of each other, smallest to largest, to allow easy placement on the fishing pole.

In one embodiment, the bottom side of the first side or first end where the rounded slots are located has a slight bevel that follows the outline to the bottom of the slots. This allows the part to be easily placed on the fishing pole and also to provide a smooth surface that prevents possible damage to the pole during placement and removal. The rounded slots are smooth and the edges are beveled.

In another embodiment, the second side or second end of the tool is curved like a hook with a slot running through a region that connects the first side to the second side. The second side or end of the tool is shaped with a curved end to ensure the fishing line stays in the slot while casting and also to provide a pocket for the debris to gather while removing the material off of the fishing line. The curved end serves as a stop for debris.

In one embodiment, the slot that extends from about the central region of the tool to the end of the tool aids in catching of debris, removal of debris, and casting smoothly while fishing.

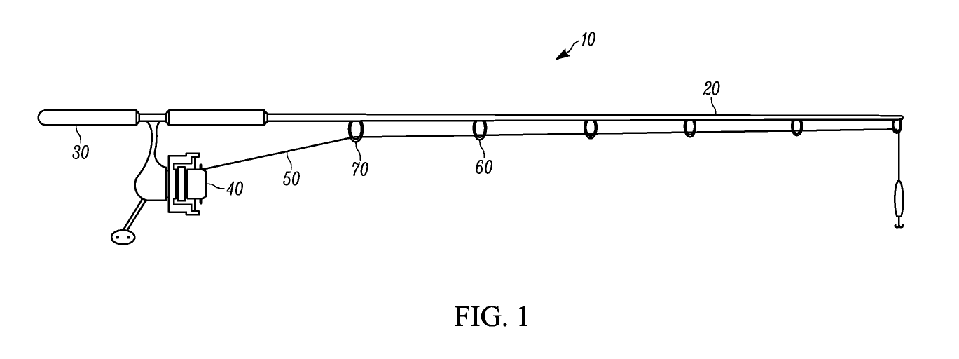

Referring to FIG. 1, a fishing rod 10, typically includes a shaft 20 a handle 30, a reel 40, fishing line 50, and a plurality of line guides 60, 70. The first line guide or eyelet 70 is located closest to the reel 40. The shaft 20 is normally conical in shape, such that it is wider at the proximal end, near the handle 30, than at the distal end of the shaft 20. This conical shape provides the shaft 20 rigidity at the proximal end, near the handle 30 and reel 40, while allowing the distal end of the shaft to be flexible so that it does not break when the fisherman reels in his or her catch.

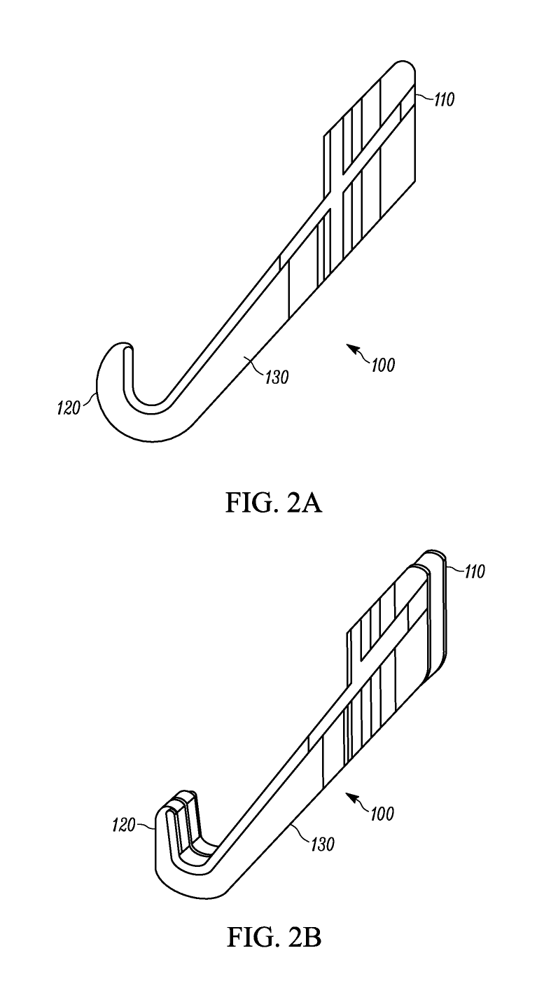

In one representative embodiment and as shown in FIGS. 2A and 2B, the tool 100 comprises a first region 110 and a second region 120, with a third region 130 extending from the first region 110 to the second region 120. In one embodiment, the tool 100 can be made of any suitable material including but not limited to plastic, ABS plastic, rubber, low density poly ethylene (LDPE), very low density polyethylene, polypropylene, polystyrene, polyethylenterephthalate, metal and ceramic material.

In one embodiment, the second region 120 has a curved end. In another embodiment, the curved end has the shape of a hook including but not limited to a “J-hook.” In still another embodiment, the second region 120 can have a hooked end.

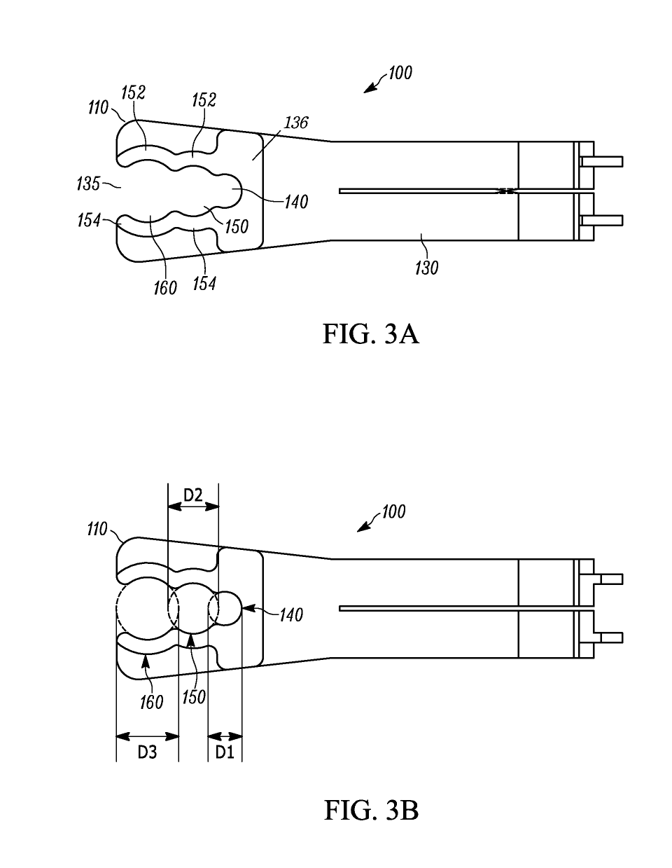

In one representative embodiment and as shown in FIG. 3A, the tool 100 can have a first region 110 that has a first end 135 and a second end that extends to the third region 130. In one embodiment, the first region 110 has a cavity or opening with one or more notches for attachment to the shaft of a fishing rod. In another embodiment, the first region can have two or more notches for attachment to the shaft of a fishing rod. In still another embodiment, the first region 110 can have three or more notches for attachment to the shaft of a fishing rod. In yet another embodiment, the first region 110 can have 4, 5, 6, 7 or more than 7 notches for attachment to the shaft of a fishing rod.

In one embodiment, a notch in the first region of the tool can have a rounded shape. In still another embodiment, the notch can be made of a top portion in the shape of a first semi-circle and a bottom portion in the shape of a second semi-circle with an open middle portion for insertion of the shaft of a fishing rod or pole.

In yet another embodiment, a notch in the first region of the tool can be made of a top portion in the shape of a first crescent moon and a bottom portion in the shape of a second crescent moon with an open middle portion for insertion of the shaft of a fishing rod or pole.

In one representative embodiment and shown in FIG. 3A, the first region 110 has a cavity or opening formed from a first sidewall, a second sidewall and a bottom portion, with the inner portion of the first sidewall 152 and the inner portion of the second sidewall 154 having one or more notches or grooves. In one embodiment, the inner portion of the first sidewall 152 and the second sidewall 154 are angled. In still another embodiment, the inner portion of the first sidewall 152 and the second sidewall 154 are tapered and narrow with increasing distance from the open end 135.

In one embodiment, when the first region 110 comprises two or more notches, the notch closest to the open end 135 will have the largest diameter as compared to the diameter of the other notches. In another embodiment, the notch located closest to the third region will have the smallest diameter as compared to the diameter of the other notches.

A representative embodiment of the first region having a cavity or opening with a first notch 140, a second notch 150, and a third notch 160 is shown in FIG. 3A. The first notch 140 is located closest to the third region 130 and has the smallest diameter as compared to the diameter of the other notches. The second notch 150 is located between the first notch 140 and the third notch 160. The second notch 150 has a larger diameter that the first notch 140 but a smaller diameter than the third notch 160. The third notch 160 has a larger diameter than the first notch 140 and the second notch 150. The first notch 140, second notch 150, and third notch 160 are located in series, one after the other.

Representative diameters of the notches of the first region are shown in FIG. 3B. In one representative embodiment, the first notch 140 has a diameter (D1) of about 0.140±0.002 inches when measured if the top angular portion and the bottom angular portion are connected in the shape of a circle. In another representative embodiment, the second notch 150 has a diameter (D2) of about 0.205±0.002 inches when measured if the top angular portion and the bottom angular portion are connected in the shape of a circle. In yet another embodiment, the third notch 160 has a diameter (D3) of about 0.255±0.002 inches if the top angular portion and the bottom angular portion are connected in the shape of a circle.

In one embodiment, the first notch has a diameter from about 0.10 inches to about 0.25 inches. In another embodiment, the first notch has a diameter of at least 0.1 inches, or at least 0.15 inches, or at least 0.20 inches.

In another embodiment, the second notch has a diameter from about 0.15 inches to about 0.25 inches. In another embodiment, the second notch has a diameter of at least 0.15 inches, or at least 0.20 inches, or at least 0.25 inches.

In another embodiment, the third notch has a diameter from about 0.20 inches to about 0.30 inches. In another embodiment, the third notch has a diameter of at least 0.20 inches, or at least 0.25 inches, or at least 0.30 inches.

In one embodiment, when the opening or cavity of the first region 110 of the tool 100 has two or more notches, the diameter of the second notch, which is closest to the open end 135 of the first region 110, has a diameter that is from about 10% to about 60% greater than the diameter of the first notch. In another embodiment, the diameter of the second notch can have a diameter that is from about 20% to about 45% or from about 25% to about 45% or from about 30% to about 45% or from about 35% to about 45% or from about 40% to about 45% greater than the diameter of the first notch.

In one embodiment, the diameter of the second notch is about 10%, 20%, 30%, 40%, 50%, 60%, or 70% greater than the diameter of the first notch. In one embodiment, the diameter of the second notch can be at least 30% greater than the diameter of the first notch.

In one embodiment, when opening or cavity of the first region of the tool 100 has three notches, the diameter of the third notch, which is closest to the open end of the first region, has a diameter that is from about 10% to about 60% greater than the diameter of the second notch. In another embodiment, the diameter of the third notch can have a diameter that is from about 10% to about 35% or from about 15% to about 35% or from about 20% to about 35% or from about 25% to about 35% or from about 30% to about 35% greater than the diameter of the second notch.

In one embodiment, the diameter of the third notch is about 10%, 20%, 30%, 40%, 50%, 60%, or 70% greater than the diameter of the second notch. In one embodiment, the diameter of the third notch can be at least 20% greater than the diameter of the second notch.

In one embodiment, when the opening or cavity of the first region 110 comprises two or more notches, the notch closest to the open end 135 will the largest opening as compared to the opening of the other notches. The notch located closest to the third region 130 will have the smallest opening as compared to the opening of the other notches.

The first notch 140 is located closest to the third region 130 and has the smallest opening as compared to the opening of the other notches. The second notch 150 is located between the first notch 140 and the third notch 160. The second notch 150 has a larger opening that the first notch 140 but a smaller opening than the third notch 160. The first notch 140, second notch 150, and third notch 160 are located in series, one after the other.

In one embodiment, when the first region 110 of the tool 100 has two or more notches, the second notch, which is closest to the open end of the first region, has an opening that is from about 10% to about 60% greater than the opening of the first notch. In another embodiment, the opening of the second notch can have an opening that is from about 20% to about 45% or from about 25% to about 45% or from about 30% to about 45% or from about 35% to about 45% or from about 40% to about 45% greater than the opening of the first notch.

In one embodiment, the opening of the second notch is about 10%, 20%, 30%, 40%, 50%, 60%, or 70% greater than the opening of the first notch. In one embodiment, the opening of the second notch can be at least 30% greater than the opening of the first notch.

In one embodiment, when the first region of the tool 100 has three notches, the third notch, which is closest to the open end of the first region, has an opening that is from about 10% to about 60% greater than the opening of the second notch. In another embodiment, the third notch can have an opening that is from about 10% to about 35% or from about 15% to about 35% or from about 20% to about 35% or from about 25% to about 35% or from about 30% to about 35% greater than the opening of the second notch.

In one embodiment, the third notch has an opening that is about 10%, 20%, 30%, 40%, 50%, 60%, or 70% greater than the opening of the second notch. In one embodiment, the opening of the third notch can be at least 20% greater than the opening of the second notch.

In one embodiment, the tool comprises a body having a first region with a cavity, the cavity formed by a first sidewall with series of grooves, and a second sidewall with a second series of grooves. In one embodiment, the grooves are curved. In another embodiment, the first sidewall has 1, 2, 3, 4, 5, 6 or more than 6 grooves. In yet another embodiment, the second sidewall has 1, 2, 3, 4, 5, 6 or more than 6 grooves.

In one embodiment, the tool comprises a body having a first region with a cavity, the cavity formed by a first sidewall with the inner portion of the sidewall having a series of grooves, and a second sidewall with the inner portion of the second sidewall having a second series of grooves. In one embodiment, the grooves are curved.

In one embodiment, the tool comprises a body having a first portion that attaches to a shaft of a fishing rod, the first portion having a cavity formed by a first sidewall with the inner portion of the sidewall having a series of grooves, and a second sidewall with the inner portion of the second sidewall having a second series of grooves. In one embodiment, the grooves are curved. In one embodiment, the grooves are sized to accommodate different sized shafts of fishing rods. In on embodiment, a groove on the first second sidewall 152 is identical to a groove on the second sidewall 154, and together form an aperture of insertion of a shaft of a fishing rod.

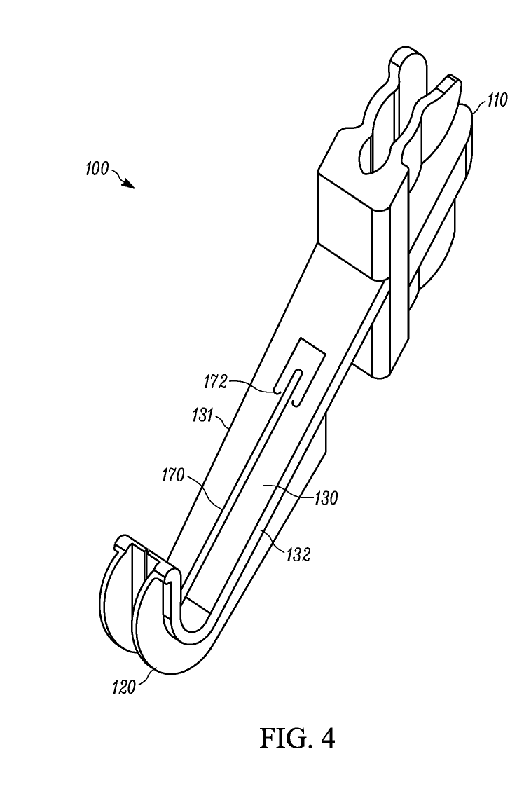

As shown in FIG. 4, the third region 130 has a slot 170. In one embodiment, the slot 170 extends to the second region 120. In one embodiment, the slot 170 extends to the end of the curved second region 120. In one embodiment, the slot 170 is located centrally between the first sidewall of the third region 131 and a second sidewall of the third region 132.

In one embodiment, the slot 170 has is the same width 172 from one end to the other end. In another embodiment, the slot 170 has a tapered gap with the wider end being located in the third region and the narrow end located in the second region. In still another embodiment, the slot 170 has a tapered gap with the narrow end being located in the third region and the wide end located in the second region.

In one embodiment, the slot 170 is the same width 172 from one end to the other end, wherein the gap is from about 0.010 inches to about 0.040 inches. In one embodiment, the slot 170 is the same width 172 from one end to the other end, wherein the gap is from about 0.015 inches to about 0.035 inches. In one embodiment, the slot 170 is the same width 172 from one end to the other end, wherein the gap is from about 0.018 inches to about 0.030 inches. In one embodiment, the slot 170 is the same width 172 from one end to the other end, wherein the gap is from about 0.020 inches to about 0.025 inches.

In one embodiment, the slot 170 is the same width 172 from one end to the other end, wherein the gap is at least 0.015 inches. In one embodiment, the slot 170 is the same width 172 from one end to the other end, wherein the gap is less than 0.025 inches.

In one embodiment, the slot 170 is the same width 172 from one end to the other end, wherein the gap is about 0.022 inches.

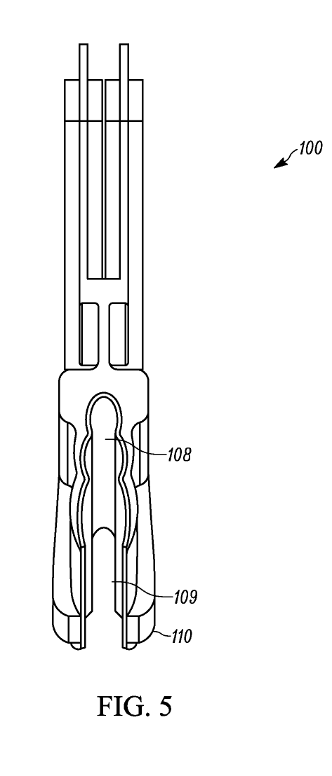

FIG. 5 provides another representative view of the first region 110 depicting an open central region for insertion of a shaft of a fishing rod. The first region 110 has an opening that widens progressively from a first end of the opening 108 to a second end of the opening 109. The first region 110 has an opening that narrows progressively from a second end of the opening 109 to a first end of the opening 108.

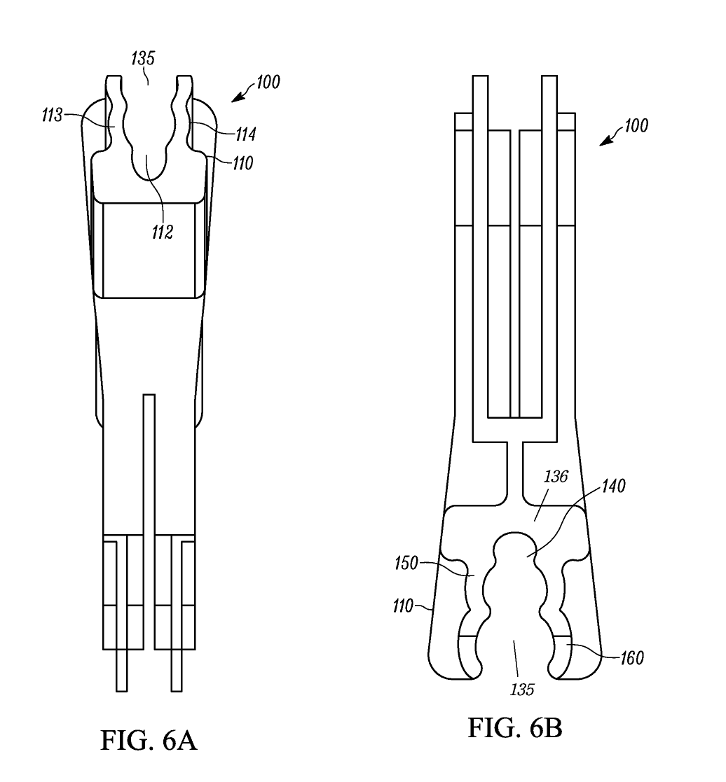

As shown in FIG. 6A, the tool comprises a first region 110 that has a cavity or opening 112. The cavity or opening 112 is formed by a first sidewall 113 and a second sidewall 114. The first sidewall 113 and the second sidewall 114 are curved with the sidewalls narrowing as they move inward from the open end 135 of the first region 110. In one embodiment, the distance from the first sidewall 113 to the second sidewall 114 near the open end 135 of the first region 110 decreases as the sidewalls move inward and eventually connect.

A representative embodiment is shown in FIG. 6B. The inner sidewalls are curved with a series of notches or grooves for insertion of a shaft of a fishing pole. The curved shape of the inner sidewalls creates a first notch 140, a second notch 150, and a third notch 160, which is located closest to the open end 135 of the first region. The distance from the first sidewall to the second sidewall of the third notch 160 is greater than the distance from the first sidewall to the second sidewall of the second notch 150.

In another embodiment, the distance from the first sidewall to the second sidewall of the second notch 150 is greater than the distance from the first sidewall to the second sidewall of the first notch 140.

As shown in FIGS. 6A and 6B, the tool comprises a body having a first region with a cavity or opening, the cavity formed from a first sidewall, a second sidewall and a bottom portion 136. The inner portion of the first sidewall and second sidewall have a series of corresponding grooves or notches. Groove 1 on inner portion of the first sidewall matches groove 1 on the inner portion of the second sidewall. Groove 2 on inner portion of the first sidewall matches groove 2 on the inner portion of the second sidewall. The corresponding grooves form an aperture for holding a shaft of a fishing rod. In one embodiment, the corresponding grooves form an aperture for securely holding a shaft of a fishing rod.

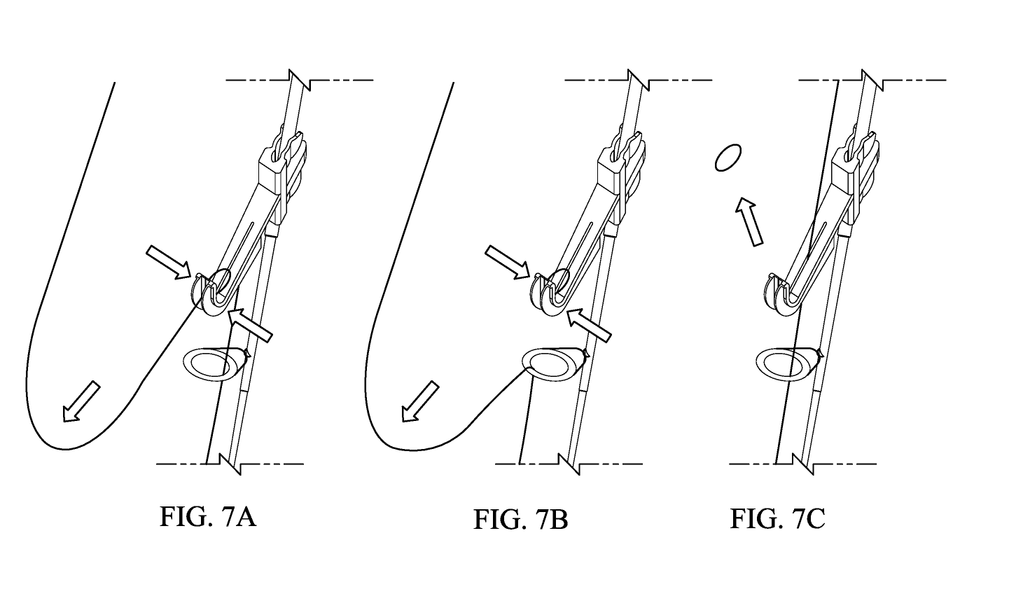

A representative method for removal of debris from the fishing line is shown in FIG. 7. As depicted in FIG. 7A, debris accumulates on the hooked or curved portion of the second end of the tool. To remove the debris, pinch or push end the ends of the hooked curved portion, and release the line. As shown in FIG. 7B, the debris remains on the hooked or curved portion of the second end while the fishing line is now released. As shown in FIG. 7C, the debris can be removed from the hook and the line can be reinserted.

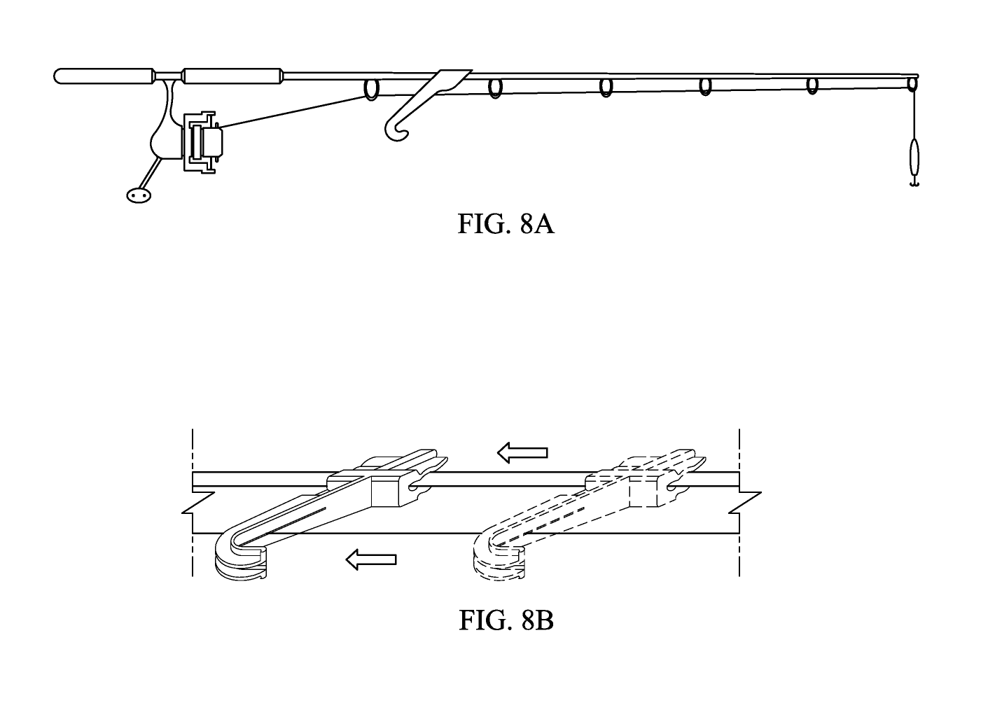

FIG. 8A and FIG. 8B are depictions of the tool as disclosed herein attached to a shaft of a fishing rod. The tool 100 is attached to the shaft of the fishing rod above the first eyelet of the rod. The tool 100 remains attached to the shaft while casting and fishing. The tool 100 does not interfere with casting the line. The tool and methods disclosed herein are further described in the numbered paragraphs:

1. A pole-attachable fishing tool comprising a body, the body having (a) a first region with at least a first notch and a second notch, each notch sized to receive a shaft of a fishing pole; (b) a second region that is curved at the end, and (c) a third region coupling the first region to the second region, and (d) a slot extending from about the third region of the body to the second region that allows for insertion of a fishing line.

2. A pole-attachable fishing tool comprising a body, the body having (a) a first region with at least a first notch and a second notch, wherein each notch is formed by two semi-circles; (b) a second region that is curved at the end, and (c) a third region coupling the first region to the second region, and (d) a slot extending from about the third region of the body to the second region that allows for insertion of a fishing line.

3. A pole-attachable fishing tool comprising a body, the body having (a) a first region with at least a first notch and a second notch, wherein each notch is formed by two crescent shapes; (b) a second region that is curved at the end, and (c) a third region coupling the first region to the second region, and (d) a slot extending from about the third region of the body to the second region that allows for insertion of a fishing line.

4. A pole-attachable fishing tool comprising a body, the body having (a) a first region comprising a first sidewall, and a second sidewall, the inner portions of the first sidewall and second sidewalls are curved, and move away from one another to create an open region sized to receive a shaft of a fishing rod; (b) a curved second region, and (c) a third region coupling the first region to the second region, and (d) a slot extending from about the third region of the body to the second region that allows for insertion of a fishing line.

5. A pole-attachable fishing tool comprising a body having a first region with a first end and a second end and an opening that narrows progressively from the first end to the second end, a second region with a curved end; and a third region connecting the first and second regions, wherein the opening is sized to accommodate attachment of at least two different sized shafts of fishing rods.

6. A pole-attachable fishing tool comprising a body having a first region with an open cavity, a second region with a curved end; and a third region connecting the first and second regions, wherein the open cavity can accommodate attachment of at least two different sized shafts of fishing rods.

7. A pole-attachable fishing tool comprising a body having a first region with an open cavity formed from a first angular sidewall and a second angular sidewall, a second region with a curved end; and a third region connecting the first and second regions, wherein the open cavity can accommodate attachment of at least two different sized shafts of fishing rods.

8. A tool comprising a body having a first region with a cavity, the cavity formed by a first sidewall with series of grooves, and a second sidewall with a second series of grooves, a second region with a curved end, and a third region connecting the first and second regions, wherein the cavity can accommodate attachment of at least two different sized shafts of fishing rods.

9. A tool comprising a body having a first region with a cavity, the cavity formed by a first sidewall with the inner portion of the sidewall having a series of grooves, and a second sidewall with the inner portion of the second sidewall having a second series of grooves, and a second region with a curved end and a slot.

10. A tool comprising a body having (a) a first portion that attaches to a shaft of a fishing rod, the first portion having a cavity formed by a first sidewall with the inner portion of the sidewall having a series of grooves, and a second sidewall with the inner portion of the second sidewall having a second series of grooves, (b) a curved second portion, and (c) a third portion coupling the firs portion to the second portion, and (d) a slot extending from about the third portion of the body to the second portion that allows for insertion of a fishing line

11. The pole-attachable fishing tool of any of the preceding paragraphs, wherein the first region has as first surface and is beveled on the first surface.

12. The pole-attachable fishing tool of any of the preceding paragraphs, wherein the first notch and the second notch are positioned in series.

13. The pole-attachable fishing tool of any of the preceding paragraphs, wherein each of the first and second notch are formed from a first angular portion, an open middle portion, and a second angular portion.

14. The pole-attachable fishing tool of any of the preceding paragraphs, wherein the middle portion of the second notch has a larger opening as compared to the opening of the middle portion of the first notch.

15. The pole-attachable fishing tool of any of the preceding paragraphs, wherein the opening of the second notch is from about 40% to about 50% greater than the opening of the first notch.

16. The pole-attachable fishing tool of any of the preceding paragraphs, further comprising a third notch located after the second notch.

17. The pole-attachable fishing tool of any of the preceding paragraphs, wherein the third notch is formed from a first angular portion, an open middle portion, and a second angular portion.

18. The pole-attachable fishing tool of any of the preceding paragraphs, wherein the middle portion of the third notch has a larger opening than the opening of the second notch.

19. The fishing tool of any of the preceding paragraphs, wherein the slot has a uniform width.

20. The fishing tool of any of the preceding paragraphs, wherein the slot has a width from about 0.015 inches to about 0.025 inches.

21. The fishing tool of any of the preceding paragraphs, wherein the slot has a width of about 0.022 inches.

22. The pole-attachable fishing tool of any of the preceding paragraphs, further comprising a slot extending from about the center of the third region to the end of the second region.

23. The pole-attachable fishing tool of any of the preceding paragraphs, wherein the opening can accommodate attachment of at least three different sized shafts of fishing rods.

24. The pole-attachable fishing tool of any of the preceding paragraphs, wherein the third notch is formed from a first angular portion, and a second angular portion with an open middle region.

25. The pole-attachable fishing tool of any of the preceding paragraphs, wherein the second notch has a larger diameter than the first notch.

26. The pole-attachable fishing tool of any of the preceding paragraphs, wherein the second notch has a diameter that is from about 40% to about 50% greater than the diameter of the first notch.

27. The pole-attachable fishing tool of any of the preceding paragraphs, further comprising a third notch located after the second notch.

28. The pole-attachable fishing tool of any of the preceding paragraphs, wherein the third notch has a larger diameter than the second notch.

29. The pole-attachable fishing tool any of the preceding paragraphs, wherein the second and third notches each have a first sidewall and a second sidewall of a semi-circular shape.

The above examples are provided to illustrate the disclosure but not limit its scope. Other variants of the disclosure will be readily apparent to one of ordinary skill in the art and are encompassed by the appended claims and all their equivalents.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the disclosure.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the disclosure.

What is claimed is:

1. A pole-attachable fishing tool comprising a body, the body having (a) a first region with at least a first notch and a second notch, and notch sized to receive a shaft of a fishing pole; (b) a second region that is curved at the end, and (c) a third region coupling the first region to the second region, and (d) a slot extending from about the third region of the body to the second region that allows for insertion of a fishing line.

2. The pole-attachable fishing tool of claim 1, wherein the first region has as first surface and is beveled on the first surface.

3. The pole-attachable fishing tool of claim 1, wherein the first notch and the second notch are positioned in series.

4. The pole-attachable fishing tool of claim 1, wherein each of the first and second notch are formed from a first angular portion, an open middle portion, and a second angular portion.

5. The pole-attachable fishing tool of claim 1, wherein the middle portion of the second notch has a larger opening as compared to the opening of the middle portion of the first notch.

6. The pole-attachable fishing tool of claim 5, wherein the opening of the second notch is from about 40% to about 50% greater than the opening of the first notch.

7. The pole-attachable fishing tool of claim 1, further comprising a third notch located after the second notch.

8. The pole-attachable fishing tool of claim 7, wherein the third notch is formed from a first angular portion, an open middle portion, and a second angular portion.

9. The pole-attachable fishing tool of claim 8, wherein the middle portion of the third notch has a larger opening than the opening of the second notch.

10. The pole-attachable fishing tool of claim 1, wherein the slot has a uniform width.

11. The pole-attachable fishing tool of claim 1, wherein the slot has a width from about 0.015 inches to about 0.025 inches.

12. The pole-attachable fishing tool of claim 1, wherein the slot has a width of about 0.022 inches.

13. A pole-attachable fishing tool comprising a body, the body having (a) a first region that attaches to a shaft of a fishing rod, the first region having a cavity formed by a first sidewall, a second sidewall, and a bottom portion, the inner portions of the first sidewall and second sidewalls containing one or more grooves; (b) a curved second region, and (c) a third region coupling the first region to the second region, and (d) a slot extending from about the third region of the body to the second region that allows for insertion of a fishing line.

14. The pole-attachable fishing tool of claim 13, wherein the one or more grooves is 3 grooves in series.

15. A pole-attachable fishing tool comprising a body having a first region with a first end and a second end and an opening that narrows progressively from the first end to the second end, a second region with a curved end; and a third region connecting the first and second regions, wherein the opening can accommodate attachment of at least two different sized shafts of fishing rods.

16. The pole-attachable fishing tool of claim 15, further comprising a slot extending from about the center of the third region to the end of the second region.

17. The pole-attachable fishing tool of claim 15, wherein the opening can accommodate attachment of at least three different sized shafts of fishing rods.
